(19) United States
(12) Patent Application Publication
(10) Pub. No.: US 2016/0132136 A1
(43) Pub. Date: May 12, 2016

(54) DIGITAL PEN

(71) Applicant: Seiko Epson Corporation, Tokyo (JP)

(72) Inventors: Nobuyuki Otsuki, Matsumoto-shi (JP); Daigo Yamano, Matsumoto-shi (JP); Tsuyoshi Arai, Ina-shi (JP); Yohei Sakai, Suwa-shi (JP); Sei Nakanishi, Matsumoto-shi (JP)

(21) Appl. No.: 14/882,944

(22) Filed: Oct. 14, 2015

(30) Foreign Application Priority Data
Nov. 7, 2014 (JP) 2014-226723
Nov. 7, 2014 (JP) 2014-226727

(51) Int. Cl. G06F 3/0354; G06F 3/03

(52) U.S. Cl. CPC G06F 3/03545; G06F 3/0304

(57) ABSTRACT

A digital pen includes: a light emitting section; a writing section which has a tip part and transmits light emitted from the light emitting section; and a main body section which supports the writing section in a displaceable manner, detects a pressing on the writing section and causes the light emitting section to emit light. The writing section includes a support member supported by the main body section, and an elastic member which has the tip part and is held by the support member.

### BACKGROUND

1. Technical Field

The present invention relates to a digital pen.

2. Related Art

According to the related art, a system which includes a projector for projecting an image on a projection surface such as a whiteboard and a digital pen (see, for example, JP-A-2011-59768) operated on this projection surface is known. In such a system using a digital pen, as the user operates the digital pen on a projection surface (operation surface), the digital pen emits light such as infrared rays. The projector is configured to be able to detect the light emitted from the digital pen and project information about the trajectory of the digital pen on top of original image information.

The digital pen described in JP-A-2011-59768 has a shape mimicking that of a writing implement and includes a shaft, a light emitting diode which emits infrared rays, a cap, a tilt detection mechanism, a support member, and a main board.

The shaft has the light emitting diode attached to the distal end thereof and is supported by the support member in such a way as to be able to tilt. The cap is a member situated at the tip of the digital pen. The cap is formed of a material that transmits the infrared rays emitted from the light emitting diode, and is attached to the shaft in such a way as to cover the light emitting diode. The tilt detection mechanism has the function of detecting a tilt of the shaft. The main board is made up of a circuit board with circuit elements mounted thereon and causes the light emitting diode to emit light according to the result of detection by the tilt detection mechanism.

As the user holds the digital pen described in JP-A-2011-59768 in the hand and presses the cap against the projection surface, the cap and the shaft tilt. The tilt detection mechanism operates according to the tilt, and the main board causes the light emitting diode to emit light.

However, some user may operate the digital pen in such a way that the cap collides with the projection surface, when bringing the cap into contact with the projection surface. Therefore, the digital pen described in JP-A-2011-59768 has the problem of generating a collision sound which causes discomfort to the user. Also, the touch experienced in a writing operation in the state where the cap and the projection surface are in contact with each other is greatly different from the touch experienced in a writing operation on a whiteboard or the like with a marker pen or the like. Therefore, the problem of causing an uncomfortable feeling to the user arises as well.

### SUMMARY

An advantage of some aspects of the invention is to solve at least a part of the problems described above, and the invention can be implemented as the following forms or application examples.

### Application Example 1

A digital pen according to this application example includes a light emitting section and the light emitting section emits light as a tip part is pressed. The digital pen includes: a writing section which has the tip part and transmits the light emitted from the light emitting section; and a main body section which supports the writing section in a displaceable manner, detects a pressing on the writing section and causes the light emitting section to emit light. The writing section includes a support member supported by the main body section, and an elastic member which has the tip part and is held by the support member.

In the digital pen with this configuration, since the tip part of the writing section is made up of the elastic member, the elastic member is deformed when the writing section is pressed against an operation surface. This enables reduction in the collision sound generated when the writing section contacts the operation surface, and improvement in the touch experienced in the writing operation in the state where the writing section is in contact with the operation surface.

The elastic member is held by the support member, and the writing section is supported at the support member by the main body section. This enables secure holding of the elastic member, transmission of the pressing force on the writing section from the support member to the main body section, and secure detection of the pressing on the writing section by the main body section.

### Application Example 2

In the digital pen according to the application example described above, it is preferable that the elastic member is a member made up of fibrous members intertwined with each other.

According to this configuration, when the digital penis operated, the fibrous members forming the elastic member contact the operation surface and are deformed in operation. Therefore, the collision sound generated when the writing section contacts the operation surface is reduced, and since the frictional resistance of the writing section to the operation surface is low, the user can smoothly move the digital pen on the operation surface. Thus, it is possible to provide the digital pen in which the collision sound causing discomfort to the user of the digital pen is reduced and which achieves a good sense of operation.

### Application Example 3

In the digital pen according to the application example described above, it is preferable that the elastic member is a foamed member.

According to this configuration, when the digital pen is operated, the foamed member forming the elastic member contacts the operation surface and is deformed in operation. Therefore, the collision sound generated when the writing section contacts the operation surface is reduced, and since the frictional resistance of the writing section to the operation surface is low, the user can smoothly move the digital pen on the operation surface. Thus, it is possible to provide the digital pen in which the collision sound causing discomfort to the user of the digital pen is reduced and which achieves a good sense of operation.

### Application Example 4

In the digital pen according to the application example described above, it is preferable that the writing section further includes a smoothing member formed on an outer surface of the elastic member, and that the smoothing member is made of a material with higher smoothness than the elastic member and is formed to maintain tight contact with the elastic member according to deformation and restoration of the elastic member.

According to this configuration, since the smoothing member having higher smoothness than the elastic member and following the deformation and restoration of the elastic member is provided on the outer surface of the elastic member, the digital pen can be moved smoothly on the operation surface while the elasticity of the elastic member is exhibited.

Thus, it is possible to provide the digital pen in which the collision sound with the operation surface causing discomfort to the user of the digital pen is reduced and which achieves a better sense of operation.
Application Example 5

In the digital pen according to the application example described above, it is preferable that the elastic member is an elastomer.

Here, the elastomer refers to an elastic high-molecular material, for example, a rubber material or thermoplastic elastic member.

According to this configuration, since the elastic member is formed of the elastomer, the smoothing member can be formed on the outer surface of the elastic member, and the elastic member can be formed in such a way as to achieve transmission of the light emitted from the light emitting section and to have desired elasticity.

### Application Example 6

In the digital pen according to the application example described above, it is preferable that the smoothing member is a ceramic.

According to this configuration, since the smoothing member is made of the ceramic, it is possible to form the smoothing member which transmits the light emitted from the light emitting section and has higher smoothness to the operation surface than the elastic member.

### Application Example 7

In the digital pen according to the application example described above, it is preferable that the smoothing member is a material containing fluorine.

According to this configuration, it is possible to form the smoothing member easily on the outer surface of the elastic member, by a manufacturing method such as coating.

### Application Example 8

In the digital pen according to the application example described above, it is preferable that the tip part of the elastic member is formed in such a way that an outer shape of a cross section on a plane passing through a center axis of the writing section forms a curved surface which has an apex on the center axis and where the distance of the curve from the center axis becomes greater as it moves away from the apex, and that the smoothing member is provided at least on the tip part.

According to this configuration, the smoothing member can be formed more easily than in the configuration in which the smoothing member is provided on the entire outer surface of the elastic member, and the smoothing member can be brought into contact with the operation surface even if the digital pen is tilted. Thus, it is possible to provide the digital pen with an improved sense of operation while simplifying the manufacturing of the writing section with the smoothing member.

### Application Example 9

In the digital pen according to the application example described above, it is preferable that the elastic member has such elasticity that deformation starts with a smaller pressing force than a pressing force on the writing section which causes the light emitting section to emit light.

According to this configuration, as the user presses the writing section against the operation surface when operating the digital pen, the elastic member starts deformation before the light emitting section emits light. Therefore, it is possible to securely reduce the collision sound which causes discomfort to the user of the digital pen when the writing section is pressed against the operation surface.

### Application Example 10

In the digital pen according to the application example described above, it is preferable that the support member has a laminate part with which an inside of the tip part of the elastic member is laminated.

According to this configuration, since the laminate part of the support member is arranged on the inside of the tip part formed by the elastic member, the tip part, when pressed, can be supported by the laminate part. Therefore, excessive deformation of the tip part can be restrained.

### Application Example 11

In the digital pen according to the application example described above, it is preferable that the writing section has a hollow part opening on the side opposite to the tip part, and that the light emitting section is arranged in the hollow part.

According to this configuration, since the light emitting section is arranged in the hollow part of the writing section, the loss of the light emitted from the light emitting section can be restrained and the light can be efficiently transmitted outside through the writing section. Thus, it is possible to employ a small-sized light emitting section and reduce electricity consumption required for the light emission of the light emitting section.

### Application Example 12

In the digital pen according to the application example described above, it is preferable that the support member is removably supported by the main body section.

According to this configuration, since the support member is removably supported by the main body section, the writing section can be easily replaced without dismantling the main body section even if damage, stain or the like occurs on the elastic member forming the tip part.

### BRIEF DESCRIPTION OF THE DRAWINGS

The invention will be described with reference to the accompanying drawings, wherein like numbers reference like elements.

FIG. 1 is a diagram showing the schematic configuration of a display system using a digital pen according to a first embodiment.

FIG. 2 is a perspective view showing the appearance of the digital pen according to the first embodiment.

FIG. 3 is a cross-sectional view showing the digital pen according to the first embodiment.

FIG. 4A is a cross-sectional view showing a writing section according to the first embodiment.

FIG. 4B is a cross-sectional view showing an elastic member in the writing section according to the first embodiment.

FIG. 5 is a cross-sectional view for explaining a writing section and a light guide member in a digital pen according to a second embodiment.

FIG. 6 is a cross-sectional view showing a writing section according to a third embodiment.

FIG. 7 is a cross-sectional view showing a writing section and a light guide member in a digital pen according to a fourth embodiment.

FIG. 8 is a cross-sectional view showing a writing section according to a modification.

FIG. 9 is a cross-sectional view showing a writing section according to another modification.

### DESCRIPTION OF EXEMPLARY EMBODIMENTS

### First Embodiment

Hereinafter, a digital pen according to this embodiment will be described with reference to the drawings.

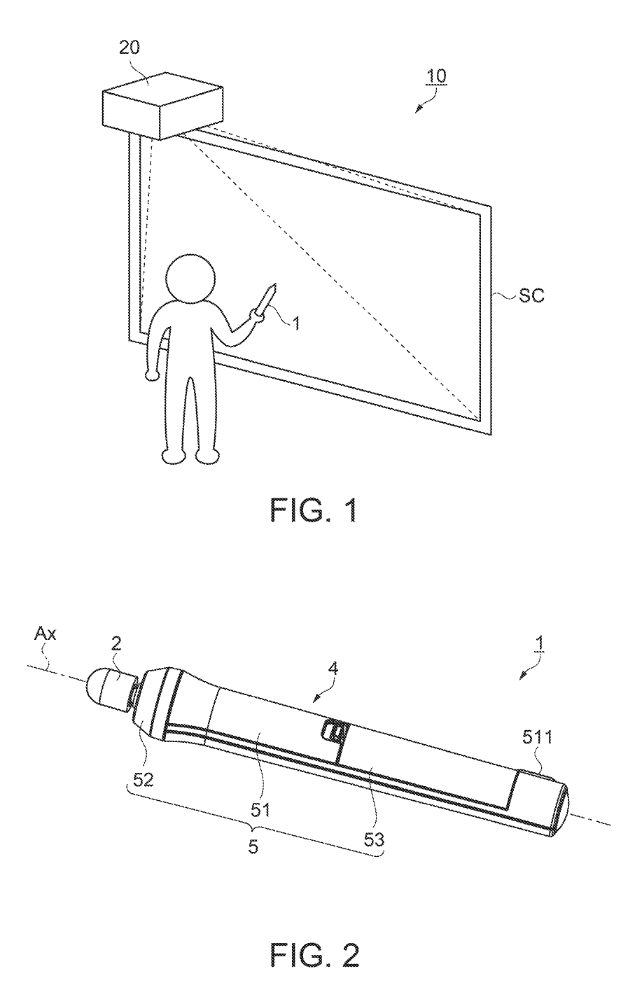

FIG. 1 is a diagram showing the schematic configuration of a display system 10 using a digital pen 1 according to the embodiment.

The display system 10 also includes a projector 20 and a whiteboard or the like having a projection surface SC and is configured to be able to display a graphic pattern, letter or the like via the operation of the digital pen 1 by the user, on top of an image projected on the projection surface SC by the projector 20.

Although not described in detail, the projector 20 has an image projection unit which projects an image corresponding to inputted image information onto the projection surface SC, and an image pickup unit which picks up an image of the projection surface SC. The projector 20 detects light (infrared rays) emitted from the digital pen 1 operated on the projection surface SC, analyzes the position of light emission on the basis of the detected information, and carries out projection of a superimposed image formed by superimposing a line indicating the trajectory of the position of light emission on the image information, or change of the image to be projected, and the like. The projection surface SC serves as an operation surface on which a tip part of the digital pen 1 is pressed and operated. Here, the tip part of the digital pen 1 refers to the part pressed against the projection surface SC by the user's operation. That is, the tip part of the digital pen 1 is pressed against the projection surface SC, not only when the digital pen 1 is operates substantially at right angles to the projection surface SC but also when the digital pen 1 is tilted with respect to the projection surface SC and operated in this state.

### Main Configuration of Digital Pen

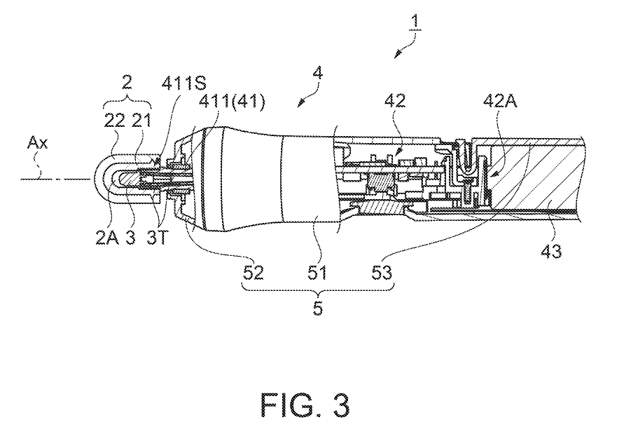

FIG. 2 is a perspective view showing the appearance of the digital pen 1. FIG. 3 is a cross-sectional view of the digital pen 1.

The digital pen 1 has a shape mimicking that of a writing implement, as shown in FIG. 2. The digital pen 1 has a writing section 2 having the tip part, a light emitting section 3 accommodated in the writing section 2, and a main body section 4 supporting the writing section 2 in a displaceable manner, as shown in FIG. 3. The light emitting section 3 emits light in response to the operation of the tip part being pressed against the projection surface SC (operation surface).

The main body section 4 has a switch mechanism 41, a circuit unit 42, a battery 43, and an outer casing 5 accommodating these members inside.

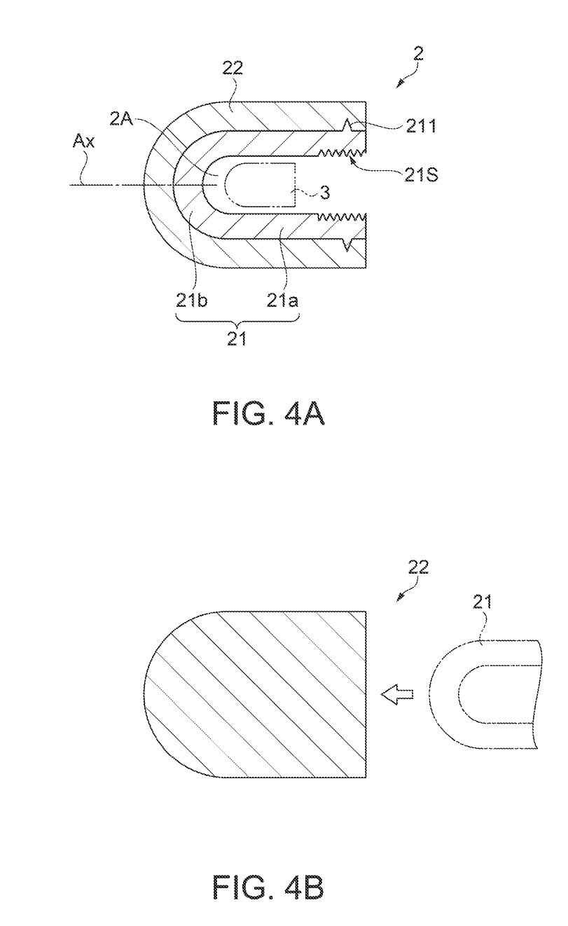

As will be described in detail below, the writing section 2 includes a support member 21 supported by the main body section 4 and an elastic member 22 supported by the support member 21, as shown in FIG. 3, and the tip part is made up of the elastic member. The writing section 2 has a hollow part 2A opening on the side opposite to the tip part, and the outside of the support member 21 is laminated with the elastic member 22. A thread groove 21S (see FIG. 4A) is provided on the inner surface of the support member 21.

The light emitting section 3 is made up of a light emitting diode which emits infrared rays. As shown in FIG. 3, the light emitting section 3 is arranged in the hollow part 2A of the writing section 2 and connected to the circuit unit 42 via a lead terminal 3T.

The switch mechanism 41, though not described in detail, has a connection member 411 connected to the light emitting section 3, as shown in FIG. 3, and a plurality of electrical connection members or the like, not shown. The switch mechanism 41 has the function of a switch which cases the light emitting section 3 to emit light.

The connection member 411 has a cylindrical part, and on the outer peripheral surface on one end side of this cylindrical part, a thread groove 411S which fits with the thread groove 21S (see FIG. 4A) of the support member 21 is formed, as shown in FIG. 3. The thread groove 411S of the connection member 411 is exposed from the outer casing 5. The side opposite to the thread groove 411S is arranged inside the outer casing 5 together with the plurality of electrical connection members.

The light emitting section 3 is exposed from the connection member 411 and arranged with the lead terminal 3T inserted in the connection member 411.

The writing section 2 is connected to the connection member 411 by having the thread groove 21S of the support member 21 fitted with the thread groove 411S of the connection member 411. That is, the writing section 2 is configured to be easily attachable and removable without dismantling the main body section 4. The light emitting section 3 and the connection member 411 are displaced with the writing section 2 when the writing section 2 is pressed.

In the switch mechanism 41, when the writing section 2 is pressed, the connection member 411 is displaced with the writing section 2, thus causing the connection state of the plurality of electrical connection members to change. Here, the displacement of the writing section 2 and the connection member 411 refers to a tilt with respect to the center axis Ax of the writing section 2 or a shift toward the main body section 4 along the center axis Ax.

The circuit unit 42 has a circuit board with an element such as a CPU (central processing unit) mounted thereon, and a connection terminal to the battery 43 or the like. The element such as a CPU functions as a control unit. The circuit unit 42 causes the light emitting section 3 to emit light in response to the operation of the switch mechanism 41 due to the displacement of the writing section 2. In this way, the main body section 4 detects the pressing on the writing section 2 and thus causes the light emitting section 3 to emit light.

The connection terminal includes a positive terminal 42A connected to the positive terminal of the battery 43, as shown in FIG. 3, and a negative terminal (not shown) connected to the negative terminal of the battery 43. The positive terminal 42A and the negative terminal are each connected to the circuit board.

The battery 43 supplies electric power to the light emitting section 3 and the circuit unit 42. The battery 43 in this embodiment is made up of a single AA-size dry cell battery.

The outer casing 5 has a substantially round columnar outer shape and has a case main body 51, a frame body 52 situated on the side of the writing section 2 of the case main body 51, and a battery lid 53, as shown in FIGS. 2 and 3.

The case main body 51 is provided with an opening on the side of the writing section 2, and the switch mechanism 41 and the circuit unit 42 are accommodated into the case main body 51 through this opening. The case main body 51 is also provided with an opening at a part on the outer surface of the columnar shape, and the battery 43 is accommodated into the case main body 51 through this opening. Also, in the case main body 51, an expanded part 511 is formed near the end on the side opposite to the writing section 2, as shown in FIG. 2. This expanded part 511 is provided with a hole (not shown) for attaching a strap. The expanded part 511 also has the function of preventing the digital pen 1 from rolling when the digital pen 1 is placed on a desk or the like.

The frame body 52 is formed in such away as to close the opening on the side of the writing section 2 of the case main body 51, as shown in FIG. 3, and is provided with a hole through which the connection member 411 of the switch mechanism 41 is inserted.

The battery lid 53 is removably arranged on the case main body 51 to cover the battery 43 accommodated in the case main body 51.

### Configuration of Writing Section

Now, the writing section 2 will be described in detail.

FIG. 4A is a cross-sectional view of the writing section 2. FIG. 4B is a cross-sectional view of the elastic member 22 in the writing section 2 and is a diagram showing the state before assembly.

The writing section 2 has the support member 21 and the elastic member 22, as shown in FIG. 4A and as described above.

The support member 21 is formed of a synthetic resin which transmits the infrared rays emitted from the light emitting section 3, and has the function of protecting the light emitting section 3 as well as the function of holding the elastic member 22 and the function of being supported by the main body section 4. As the synthetic resin forming the support member 21, for example, polycarbonate (PC), polyacetal (POM), ABS (acrylonitrile butadiene styrene), acryl (PMMA), fluorine resin, or a synthetic resin containing these as principal components, or the like can be employed.

The support member 21 has a cylindrical tubular part 21a and a laminate part 21b covering the light exiting side of the light emitting section 3, and the hollow part 2A is provided in the middle, as shown in FIG. 4A.

The thread groove 21S is provided on the inner surface of the tubular part 21a, and a protrusion 211 is formed on the outer surface.

The elastic member 22 is formed of a member made up of fibrous members intertwined with each other, a so-called felt material, and transmits the infrared rays emitted from the light emitting section 3. Specifically, the elastic member 22 is formed of a member made up mainly of a synthetic fiber, for example.

The elastic member 22 in a single product state (state before assembly) is formed without having a hollow, with the tip part formed in a convex shape and the side opposite to the tip part formed flatly, as shown in FIG. 4B. The elastic member 22 has the support member 21 inserted therein from the flat side and is arranged to cover the outer surface of the tubular part 21a and the laminate part 21b, as shown in FIG. 4A. With the laminate part 21b, the inside of the tip part of the elastic member 22 is laminated. The elastic member 22 has the fibrous members engaged with the protrusion 211 and is thus held by the support member 21. Stain prevention processing on the surface of the elastic member 22, processing to prevent the fibers from disentangling, and the like may be carried out.

As the support member 21 is inserted in the elastic member 22, the center part of the elastic member 22 is compressed more than the outer peripheral part. Therefore, the density of the center part is higher than the density of the outer peripheral part.

For the elastic member 22, a member having such elasticity that deformation starts with a smaller pressing force than the pressing force on the writing section 2 that causes the light emitting section 3 to emit light in the state where the support member 21 is inserted in the elastic member 22, is employed. That is, the elastic member 22 has such elasticity that deformation starts before the connection state of the electrical connection members in the switch mechanism 41 changes, that is, before the light emitting section 3 emits infrared rays, as the user presses the digital pen 1 against the projection surface SC.

The writing section 2 is attached to the main body section 4 by having the thread groove 21S of the support member 21 fitted with the thread groove 411S of the connection member 411, as described above. In the writing section 2, the elastic member 22 forming the tip part is deformed in response to the user's operation, and when an operation to cancel the pressing on the projection surface SC is carried out, the elastic member 22 restores the original shape. In the digital pen 1, when the tip part of the writing section 2 is pressed with a predetermined force or more, the light emitting section 3 emits light and the infrared rays emitted from the light emitting section 3 are transmitted through the support member 21 and the elastic member 22 to exit outside.

As described above, the digital pen 1 according to this embodiment can achieve the following effects.

(1) In the digital pen 1, since the tip part of the writing section 2 is made up of the elastic member 22, the elastic member 22 is deformed when the writing section 2 is pressed against the projection surface SC. Thus, it is possible to reduce the collision sound generated when the writing section 2 contacts the projection surface SC, and to improve the touch of the writing operation in the state where the writing section 2 is in contact with the projection surface SC. Therefore, it is possible to provide the digital pen 1 in which the collision sound causing discomfort to the user of the digital pen 1 is reduced and which achieves a good sense of operation.

Also, the elastic member 22 is supported by the support member 21, and the writing section 2 has the support member 21 supported by the main body section 4. This enables secure holding of the elastic member 22, transmission of the pressing force on the writing section 2 from the support member 21 to the main body section 4, and secure detection of the pressing on the writing section 2 by the main body section 4.

(2) The elastic member 22 has such elasticity that deformation starts before the light emitting section 3 emits light, as the user presses the digital pen 1 against the projection surface SC. Therefore, it is possible to securely reduce the collision sound which causes discomfort to the user of the digital pen 1 when the writing section 2 is pressed against the projection surface SC.

(3) Since the laminate part 21b of the support member 21 is arranged on the inside of the tip part made up of the elastic member 22, the tip part, when pressed, can be supported by the laminate part 21b. Therefore, excessive deformation of the tip part can be restrained and the deformed elastic member 22 can be prevented from contacting the light emitting section 3.

(4) Since the light emitting section 3 is arranged in the hollow part 2A of the writing section 2, the loss of the light emitted from the light emitting section 3 can be restrained and the light can be efficiently transmitted outside through the writing section 2. Thus, it is possible to employ the light emitting section 3 of a small size and reduce electricity consumption required for the light emission of the light emitting section 3.

(5) Since the elastic member 22 is a member made up of fibrous members intertwined with each other, when the digital pen 1 is operated, the fibrous members forming the elastic member 22 contact the projection surface SC and are deformed in operation. Therefore, the collision sound generated when the writing section 2 contacts the projection surface SC is reduced, and since the frictional resistance of the writing section 2 to the projection surface SC is low, the user can smoothly move the digital pen 1 on the projection surface SC.

(6) Since the writing section 2 is removably supported by the main body section 4, the writing section 2 can be easily replaced without dismantling the main body section 4 even if damage, stain or the like occurs on the elastic member 22 forming the tip part.

(7) Since the elastic member 22 can be attached to the support member 21 without providing a hollow part in the elastic member 22, the elastic member 22 and the writing section 2 can be easily manufactured.

Also, since the elastic member 22 is structured to be held by the support member 21 by having the protrusion 211 engaged, it is possible to easily replace the elastic member 22 only.

### Second Embodiment

A digital pen according to a second embodiment will be described with reference to the drawings. In the description below, the configurations and members similar to those of the digital pen 1 according to the first embodiment are denoted by the same reference numbers and detailed description thereof is omitted or simplified.

The digital pen according to this embodiment has a writing section 7 that is different from the writing section 2 in the first embodiment, and a light guide member 6 that is not provided in the digital pen 1 according to the first embodiment.

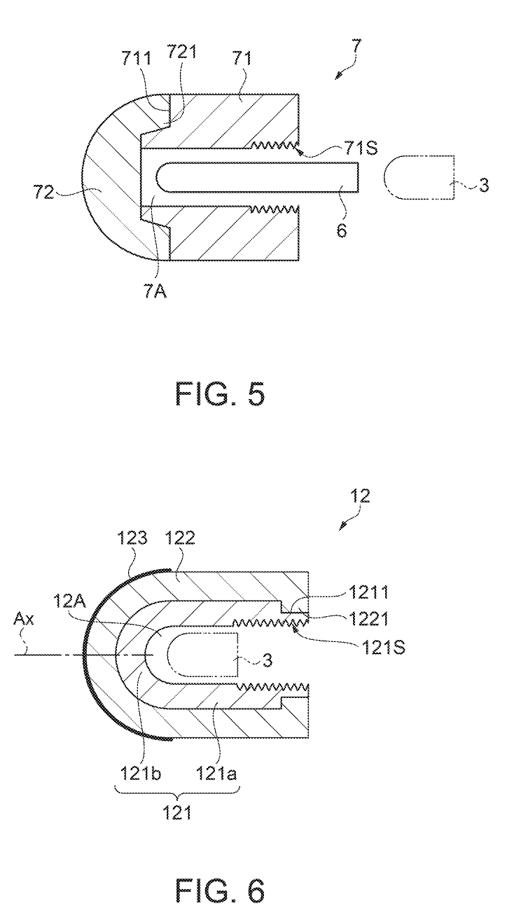

FIG. 5 is a cross-sectional view for explaining the writing section 7 and the light guide member 6 in the digital pen according to this embodiment.

The digital pen according to this embodiment is configured in such a way that the light emitting section 3 is accommodated inside the main body section (the main body section in this embodiment is not illustrated), spaced apart from the writing section 7, and that the infrared rays emitted from the light emitting section 3 are guided to a hollow part 7A of the writing section 7 by the light guide member 6, as shown in FIG. 5. The light emitting section 3 is fixed in the main body section.

The writing section 7 has an elastic member 72 having a tip part, and a support member 71 which holds the elastic member 72 and is removably supported by the main body section, as shown in FIG. 5.

The support member 71 is formed in a cylindrical shape that does not have apart equivalent to the laminate part 21b (see FIG. 4A) of the support member 21 in the first embodiment, and a thread groove 71S formed similarly to the thread groove 21S of the support member 21 in the first embodiment is formed on the inner surface. On the outer periphery on the tip part side of the support member 71, a recess part 711 is provided. As the support member 71, not only a member that transmits the infrared rays emitted from the light emitting section 3 but also a member that does not transmit infrared rays can be employed.

As the elastic member 72, a foamed member that transmits the infrared rays emitted from the light emitting section 3 is used. Specifically, the elastic member 72 is made up of a member formed by foaming a rubber material such as urethane rubber or silicon rubber, or a synthetic resin and the like, and is porous so as to enable entry of air.

The tip part of the elastic member 72 is formed in a convex shape, and a protruding part 721 to fit with the recess part 711 of the support member 71 is formed on the side opposite to the tip part, as shown in FIG. 5. The elastic member 72 is fixed to the support member 71 via an adhesive or bonding agent arranged between the protruding part 721 and the recess part 711.

The light guide member 6 has the function of guiding the infrared rays emitted from the light emitting section 3 to the inner surface of the tip part of the elastic member 72. The light guide member 6 has one end thereof arranged near the infrared-emitting side of the light emitting section 3 and has the other end extended to be arranged in the hollow part 7A. The light guide member 6 performs multiple reflection of the infrared rays incident from the one end and then causes the infrared rays to exit from the other end side.

The light guide member 6 is fixed in the main body section and formed to be spaced apart from the writing section 7 so that the light guide member 6 does not contact the writing section 7 even if the writing section 7 is displaced by a pressing. Also, the light guide member 6 and the writing section 7 may be configured to be displaced together. In this case, the light guide member 6 and the light emitting section 3 are spaced apart from each other so that the light guide member 6 does not contact the light emitting section 3 even if the writing section 7 is displaced.

The writing section 7 is supported by the main body section by having the thread groove 71S of the support member 71 fitted with the main body section, similarly to the writing section 2 in the first embodiment. In the writing section 7, the elastic member 72 forming the tip part is deformed in response to the user's operation, and when an operation to cancel the pressing on the projection surface SC is carried out, the elastic member 72 restores the original shape. In the digital pen according to this embodiment, when the tip part of the writing section 7 is pressed with a predetermined force or more, the light emitting section 3 emits light and the infrared rays emitted from the light emitting section 3 are guided by the light guide member 6 and transmitted through the elastic member 72 to exit outside.

As described above, the digital pen according to this embodiment can achieve the following effects.

Since the elastic member 72 is a foamed member, when the digital pen is operated, the foamed member forming the elastic member 72 contacts the projection surface SC and is deformed in operation. Therefore, the collision sound generated when the writing section 7 contacts the projection surface SC is reduced, and since the frictional resistance of the porous elastic member 72 to the projection surface SC is low, the user can smoothly move the digital pen on the projection surface SC.

### Third Embodiment

A digital pen according to a third embodiment will be described with reference to the drawings. In the description below, the configurations and members similar to those of the digital pen 1 according to the first embodiment are denoted by the same reference numbers and detailed description thereof is omitted or simplified.

FIG. 6 is a cross-sectional view of a writing section 12 in this embodiment.

The writing section 12 has a smoothing member 123 in addition to a support member 121 and an elastic member 122, as shown in FIG. 6.

The support member 121 is made up of a member similar to the support member 21 in the first embodiment and includes a tubular part 121a, a laminate part 121b, a hollow part 12A, and a thread groove 121S, similarly to the support member 21 (see FIG. 4A), as shown in FIG. 6. The tubular part 121a is not provided with the protrusion 211 (see FIG. 4A) of the support member 21, and a recess part 1211 is formed at an end part on the outer surface that is on the side opposite to the thread groove 121S.

The elastic member 122 is formed of an elastomer which transmits the infrared rays emitted from the light emitting section 3 and is formed to cover the outer surface of the support member 121. As the elastomer forming the elastic member 122, for example, a rubber material such as a silicon rubber, urethane rubber, chloroprene rubber or ethylene propylene rubber, or a thermoplastic elastomer or the like can be used.

Specifically, the elastic member 122 is formed to cover the outer surface of the tubular part 121a and the laminate part 121b of the support member 121, and is provided with a tip part in the area covering the outer surface of the laminate part 121b. With the laminate part 121b, the inside of the tip part of the elastic member 122 is laminated.

The tip part of the elastic member 122 is formed into a spherical outer surface, and a protrusion 1221 engaged with the recess part 1211 of the support member 121 is provided at the part covering the tubular part 121a.

The shape of the tip part of the elastic member 122 is not limited to spherical. The tip part may be formed in such a way that the outer shape of a cross section on a plane passing through the center axis Ax forms a curved surface which has an apex on the center axis Ax and where the distance of the curve from the center axis Ax becomes greater as it moves away from the apex. The shape of the tip part of the elastic member 122 may be formed, for example, in such a way that the outer surface of a cross section on a plane passing through the center axis Ax forms a parabolic shape, apart of an ellipse, a shape mimicking a parabola, or a shape mimicking a part of an ellipse, other than the spherical shape.

The elastic member 122 has such elasticity that deformation starts with a smaller pressing force than a pressing force on the writing section 12 that causes the light emitting section 3 to emit light. That is, the elastic member 122 has such elasticity that deformation starts before the main body section 4 detects displacement of the writing section 12, that is, before the light emitting section 3 emits infrared rays, as the user presses the tip part of the digital pen against the projection surface SC. When the writing section 12 is operated so as to cancel the pressing against the projection surface SC, the elastic member 122 restores the original shape.

The smoothing member 123 is formed on the outer surface of the elastic member 122, specifically, at least on the tip part of the outer surface of the elastic member 122. The smoothing member 123 is made of a material which transmits the infrared rays emitted from the light emitting section 3 and which has higher smoothness than the elastic member 122 with respect to the projection surface SC, that is, a lower frictional coefficient than the elastic member 122, in such away as to maintain tight contact with the elastic member 122 according to the deformation and restoration of the elastic member 122. That is, the smoothing member 123 is formed on the outer surface of the elastic member 122 in the state where the elasticity of the elastic member 122 can be exhibited.

As the smoothing member 123, a ceramic formed into a thin film, for example, by a preparation method utilizing sputtering, vapor deposition or the like, can be used. The ceramic forming the smoothing member 123 is formed in such a way as to securely contact the projection surface SC when the digital pen is operated, to allow the elastic member 122 to be deformed and restored according to the pressing, and to maintain tight contact with the elastic member 122 according to the deformation and restoration of the elastic member 122. The material used for the smoothing member 123 is not limited to the ceramic and may also be a material containing fluorine, for example, a fluorine resin such as polytetrafluoroethylene (PTFE) or the like. The material may be formed on the outer surface of the elastic member 122 by coating or the like. Also, particles of a material with higher smoothness than the elastic member 122, such as ceramic particles, may be used as the smoothing member 123, and the particles may be formed on the outer surface of the elastic member 122, using a binder.

In the writing section 12, the elastic member 122 forming the tip part is deformed in response to the user's operation, and when an operation to cancel the pressing on the projection surface SC is carried out, the elastic member 122 restores the original shape. In the digital pen, when the tip part of the writing section 12 is pressed with a predetermined force or more, the light emitting section 3 emits light and the infrared rays emitted from the light emitting section 3 are transmitted through the support member 121, the elastic member 122 and the smoothing member 123 to exit outside.

As described above, the digital pen according to this embodiment can achieve the following effects in addition to the effects of the first embodiment.

(1) Since the tip part of the elastic member 122 is provided with the smoothing member 123 having higher smoothness than the elastic member 122 and following the deformation and restoration of the elastic member 122, the digital pen can be smoothly moved on the projection surface SC while the elasticity of the elastic member 122 is exhibited.

Therefore, it is possible to provide the digital pen in which the collision sound with the projection surface SC causing discomfort to the user of the digital pen is reduced and which achieves a better sense of operation.

(2) Since the elastic member 122 is made up of an elastomer, it is possible to form the elastic member 122 in such a way as to transmit the infrared rays emitted from the light emitting section 3 and to have desired elasticity.

(3) Since the smoothing member 123 is made up of a ceramic, it is possible to form the smoothing member which transmits the infrared rays emitted from the light emitting section 3 and which has higher smoothness on the projection surface SC than the elastic member 122.

(4) The tip part of the elastic member 122 is formed as a curved surface as described above and the smoothing member 123 is formed at least on the tip part of the elastic member 122. Therefore, the smoothing member 123 can be formed more easily than in the configuration in which the smoothing member 123 is provided on the entire outer surface of the elastic member 122, and the smoothing member 123 can be brought into contact with the projection surface SC even if the digital pen is tilted. Thus, it is possible to provide the digital pen in which the sense of operation is improved while the manufacturing of the writing section 12 is simplified.

### Fourth Embodiment

A digital pen according to a fourth embodiment will be described with reference to the drawings. In the description below, the configurations and members similar to those of the digital pen according to the third embodiment are denoted by the same reference numbers and detailed description thereof is omitted or simplified.

The digital pen according to this embodiment has a writing section 17 that is different from the writing section 12 in the third embodiment, and a light guide member 6 that is not provided in the digital pen according to the third embodiment.

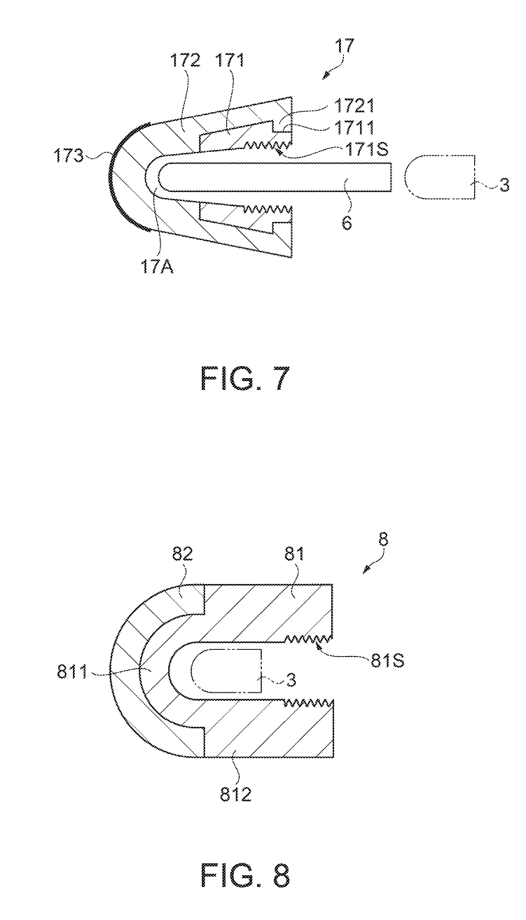

FIG. 7 is a cross-sectional view for explaining the writing section 17 and the light guide member 6 in the digital pen according to this embodiment.

The digital pen according to this embodiment is configured in such a way that the light emitting section 3 is accommodated inside the main body section (the main body section in this embodiment is not illustrated), spaced apart from the writing section 17, and that the infrared rays emitted from the light emitting section 3 are guided to a hollow part 17A of the writing section 17 by the light guide member 6, as shown in FIG. 7. The light emitting section 3 is fixed in the main body section.

The writing section 17 has an elastic member 172 having a tip part, and a support member 171 which is arranged on the inner side of the elastic member 172, thus holds the elastic member 172 and is removably supported by the main body section, as shown in FIG. 7. The writing section 17 has the hollow part 17A opening on the side opposite to the tip part, and a smoothing member 173 is formed on the tip part of the elastic member 172.

The support member 171 is formed in a cylindrical shape that does not have apart equivalent to the laminate part 121b (see FIG. 6) of the support member 121 in the third embodiment, and has a thread groove 171S and a recess part 1711 formed similarly to the thread groove 121S and the recess part 1211 of the support member 121. Also, the outer surface other than the recess part 1711 of the support member 171 is tilted in such a way that the outer diameter becomes smaller as it goes toward the tip part. The support member 171 is not limited to the member that transmits the infrared rays emitted from the light emitting section 3, and a member that does not transmit infrared rays may also be employed.

The elastic member 172 is formed to cover the outer surface of the support member 171, and the inner surface on the tip part side and the inner surface of the support member 171 form the hollow part 17A. The elastic member 172 is also provided with a protrusion 1721 engaged with the recess part 1711 of the support member 171, and the outer surface of the part covering the outer surface of the support member 171 is tilted in such a way that the outer diameter becomes smaller as it goes toward the tip part.

The light guide member 6 is configured similarly to the light guide member 6 described in the second embodiment and guides the infrared rays emitted from the light emitting section 3 to the inner surface of the tip part of the elastic member 172.

In the digital pen according to this embodiment, the elastic member 172 is deformed in response to an operation on the projection surface SC, and when the elastic member is pressed with a predetermined force or more, the light emitting section 3 emits light. The infrared rays emitted from the light emitting section 3 are guided by the light guide member 6 and transmitted through the elastic member 172 and the smoothing member 173 to exit outside.

As described above, the digital pen according to this embodiment can achieve the following effects.

(1) Since the support member 171 is in the shape without having a part equivalent to the laminate part 121b of the support member 121 in the third embodiment, the tip part of the writing section 17 can be miniaturized. Therefore, the user can accurately point at a desired position on the projection screen SC. Thus, it is possible to provide the digital pen in which the collision sound with the projection surface SC causing discomfort to the user of the digital pen is reduced and which achieves a better sense of operation.

(2) Since the light emitting section 3 is arranged spaced apart from the writing section 17 and the infrared rays from the light emitting section 3 are guided to the writing section 17 by the light guide member 6, the degree of freedom in the arrangement of the light emitting section 3 is increased.

(3) Since the support member 171 can employ a member that does not transmit the infrared rays from the light emitting section 3, the degree of freedom in the material selection for the support member 171 is increased.

The above embodiments may be altered as follows.

While the elastic member 22 in the first embodiment is formed to cover the entire outer surface of the support member 21, the elastic member 22 may be configured not to cover the entire outer surface of the support member 21 as long as the elastic member 22 has at least a tip part.

FIG. 8 is a cross-sectional view showing a writing section 8 according to a modification.

The writing section 8 has a support member 81 and an elastic member 82, as shown in FIG. 8.

The support member 81 includes a laminate part 811 covering the light exiting side of the light emitting section 3, and a cylindrical tubular part 812 covering the lateral side of the light emitting section 3, and the outer surface of the laminate part 811 is formed to be recessed from the outer surface of the tubular part 812, as shown in FIG. 8. The inner surface shape of the support member 81 is formed similarly to the support member 21 in the first embodiment, and a thread groove 81S fitted with the thread groove 411S of the connection member 411 is provided thereon.

The elastic member 82 in a single product state (state before assembly), similarly to the elastic member 22 in the first embodiment, has the tip part formed in a convex shape and the side opposite to the tip part formed flatly, though not illustrated. The elastic member 82 has the support member 81 inserted therein from the flat side and is attached to the outer surface of the laminate part 811 via an adhesive or bonding agent, as shown in FIG. 8.

With the configuration according to this modification, the elastic member 82 can be held on the support member 81 with a smaller amount of compression than the amount of compression of the elastic member 22 at the time of assembling the writing section 2 in the first embodiment.

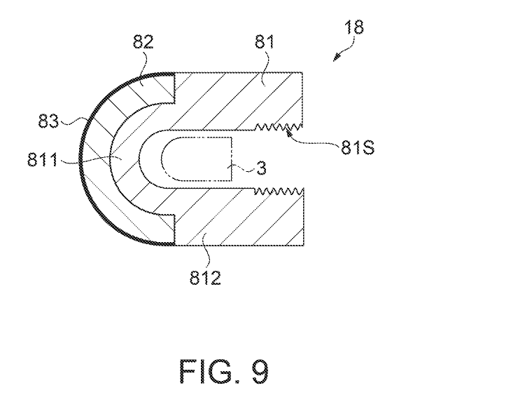

FIG. 9 is a cross-sectional view showing a writing section 18 according to another modification.

The writing section 18 has the configuration of the writing section 8 shown in FIG. 8, with a smoothing member 83 added thereto. The smoothing member 83 uses a material similar to the smoothing member 123 in the third embodiment and is formed on the outer surface of the elastic member 82. As the member forming the elastic member 82 in the writing section 18, an elastomer is preferable.

While the configuration in which the light emitting section 3 emits infrared rays is described in the embodiments, the light emitting section 3 may emit light in a different wavelength range from infrared rays and the writing sections 2, 7, 8, 12, 17, 18 may transmit the light in this wavelength range. The light guide member 6 may made up of a member which guides the light in this wavelength range.

In the digital pen according to the second embodiment, the support member 71 and the light guide member 6 are formed as separate members. However, the support member 71 and the light guide member 6 may be formed integrally. Similarly, the support member 171 and the light guide member 6 in the fourth embodiment may be formed integrally.

The main body section 4 in the embodiments is configured to detect the pressing on the writing section 2, utilizing the change in the connection state of the electrical connection members in the switch mechanism 41 due to the displacement of the writing section 2 (connection member 411). However, this configuration is not limiting. For example, a detection device such as a piezoelectric element or strain gauge for detecting the deformation of the connection member 411 may be provided instead of the switch mechanism 41, and the main body section 4 may detect the pressing on the writing section 2 on the basis of the result of the detection by this detection device.

In the embodiments, the configuration in which the digital pen 1 is used in the display system 10 having the projector 20 for projecting an image from the front side of the projection surface SC is described. However, the digital pen 1 may be used in other display systems than this configuration. For example, a configuration in which a rear-type projector which projects an image from the back side of the projection surface is used and in which the digital pen 1 is used on this projection surface as an operation surface, or a configuration in which a liquid crystal display, CRT (cathode ray tube), plasma display, organic EL display or the like is used instead of the projection surface where an image is projected, and in which the digital pen 1 is used on the display surface provided in these devices, as an operation surface, may be employed.

The present application claim priority from Japanese Patent Application No. 2014-226723 filed on Nov. 7, 2014, and No. 2014-226727 filed on Nov. 7, 2014, which is hereby incorporated by reference in its entirety.

What is claimed is:

1. A digital pen including a light emitting section in which the light emitting section emits light as a tip part is pressed, the digital pen comprising:
a writing section which has the tip part and transmits the light emitted from the light emitting section; and
a main body section which supports the writing section in a displaceable manner, detects a pressing on the writing section and causes the light emitting section to emit light,
the writing section including
a support member supported by the main body section; and
an elastic member which has the tip part and is held by the support member.

2. The digital pen according to claim 1, wherein
the elastic member is a member made up of fibrous members intertwined with each other.

3. The digital pen according to claim 1, wherein
the elastic member is a foamed member.

4. The digital pen according to claim 1, wherein
the writing section further includes
a smoothing member formed on an outer surface of the elastic member, and
the smoothing member is made of a material with higher smoothness than the elastic member and is formed to maintain tight contact with the elastic member according to deformation and restoration of the elastic member.

5. The digital pen according to claim 4, wherein
the elastic member is an elastomer.

6. The digital pen according to claim 4, wherein
the smoothing member is a ceramic.

7. The digital pen according to claim 4, wherein
the smoothing member is a material containing fluorine.

8. The digital pen according to claim 4, wherein
the tip part of the elastic member is formed in such a way that an outer shape of a cross section on a plane passing through a center axis of the writing section forms a curved surface which has an apex on the center axis and where the distance of the curve from the center axis becomes greater as it moves away from the apex, and
the smoothing member is provided at least on the tip part.

9. The digital pen according to claim 1, wherein
the elastic member has such elasticity that deformation starts with a smaller pressing force than a pressing force on the writing section which causes the light emitting section to emit light.

10. The digital pen according to claim 1, wherein
the support member has a laminate part with which an inside of the tip part of the elastic member is laminated.

11. The digital pen according to claim 1, wherein
the writing section has a hollow part opening on the side opposite to the tip part, and
the light emitting section is arranged in the hollow part.

12. The digital pen according to claim 1, wherein
the support member is removably supported by the main body section.
